(19) United States
(12) Patent Application Publication
(10) Pub. No.: US 2026/0064729 A1
(43) Pub. Date: Mar. 5, 2026

(54) SYSTEMS AND METHODS FOR QUERY DISAMBIGUATION

(71) Applicant: ADOBE INC., SAN JOSE, CA (US)

(72) Inventors: Md Mehrab Tanjim, Santa Clara, CA (US); Ryan A. Rossi, San Jose, CA (US); Sungchul Kim, San Jose, CA (US); Xiang Chen, Palo Alto, CA (US); Tong Yu, Fremont, CA (US); Ritwik Sinha, Cupertino, CA (US); Uttaran Bhattacharya, Sunnyvale, CA (US); Iftikhar Ahamath Burhanuddin, Bengaluru, Karnataka (IN); Prithvi Bhutani, Lynnwood, WA (US); Abhisek Trivedi, South Jordan, UT (US); Jiabin Geng, Lehi, UT (US); Said Kobeissi, Lovettsville, VA (US); Brandon Galen Mooso, South Jordan, UT (US); Michael Edwin Rimer, Lindon, UT (US); Andrei Zugravu, Bucharest (RO); Razvan-Alexandru Balan, Bucharest (RO); Wei Zhang, Great Falls, VA (US); Jordan Henson Walker, Lehi, UT (US); William Brandon George, Pleasant Grove, UT (US); Guillaume Lucien Jean Escarguel, San Diego, CA (US)

(21) Appl. No.: 18/823,797

(22) Filed: Sep. 4, 2024

(51) Int. Cl. G06F 16/332; G06F 16/383

(52) U.S. Cl. CPC G06F 16/3322; G06F 16/3329; G06F 16/383

(57) ABSTRACT

A method, apparatus, non-transitory computer readable medium, and system for query disambiguation include obtaining a query including an ambiguous element, where the ambiguous element corresponds to an ambiguity category, and selecting a plurality of candidate elements by retrieving the plurality of candidate elements based on the ambiguity category and computing a distance between the ambiguous element and each of the plurality of candidate elements. Some embodiments include generating a plurality of modified queries based on the query by replacing the ambiguous element from the query with each of the plurality of candidate elements, respectively.

### BACKGROUND

Data analytics chatbots are computer-based applications that provide responses to user queries regarding data stored in a database by mapping the user queries to the data. However, user queries can be ambiguous, and conventional data analytics chatbots are unable to accurately respond to ambiguous queries. Some data analytics chatbots use machine learning model trained to process user queries. However, it is challenging to train a machine learning model to have a level of semantic understanding that enables responding to ambiguous queries. Furthermore, data processing systems can ask a series of follow-up questions to resolve an ambiguous word in a query, but it can be inefficient to exchange multiple rounds of questions and answers.

### SUMMARY

Systems and methods are described for disambiguating an ambiguous query by replacing an ambiguous element in the query according to a slot-filling algorithm. The slot-filling algorithm includes identifying and retrieving a set of replacement elements based on an ambiguity category and respective similarities between the ambiguous element and the set of replacement elements, and generating a set of suggested queries by replacing the ambiguous element in the query with each of the set of replacement elements.

Therefore, embodiments of the disclosure improve on conventional data analytics chatbot technology by enabling efficient query disambiguation that avoids a computationally expensive training or use of machine learning models to predict a clarifying question that would be provided to the user in response to the ambiguous query. Additionally, by identifying the set of replacement elements based on the ambiguity category, embodiments of the present disclosure reduce a set of potential replacement elements from which the set of replacement elements are drawn, which is more efficient than identifying the set of replacement elements based on every element stored in a database. Still further, generating a set of suggested queries by replacing the ambiguous element with the set of replacement elements provides directly stated options to the user and helps to avoid multiple inefficient rounds of questions and answers to resolve an ambiguity of the query.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 shows an example of a data processing system that employs a query disambiguation method according to aspects of the present disclosure.

FIG. 2 shows an example of a method for generating a set of modified queries using a disambiguation method according to aspects of the present disclosure.

FIG. 3 shows an example of a data processing system that employs a query disambiguation method according to aspects of the present disclosure.

FIG. 4 shows an example of a data processing apparatus that selects a set of candidate elements using a set of candidate element embeddings according to aspects of the present disclosure.

FIG. 5 shows an example of a data processing apparatus that performs a search based on a replacement query according to aspects of the present disclosure.

FIG. 6 shows an example of a data processing apparatus that generates a reply to a replacement query according to aspects of the present disclosure.

FIG. 7 shows an example of a method for generating a set of modified queries according to aspects of the present disclosure.

FIG. 8 shows an example of a method for generating a modified query by replacing multiple ambiguous elements of a query according to aspects of the present disclosure.

FIG. 9 shows an example of a method for selecting the modified query of FIG. 8 according to aspects of the present disclosure.

### DETAILED DESCRIPTION

### Overview

Data analytics chatbots are computer-based applications that provide responses to user queries regarding data stored in a database by mapping the user queries to the data. However, user queries can be ambiguous, and conventional data analytics chatbots are unable to accurately respond to ambiguous queries. Accordingly, the present disclosure describes systems and methods for providing accurate responses to ambiguous queries by identifying replacement terms from a set of unambiguous candidates and providing alternative queries that include the replacement terms. In some embodiments, the candidates are filtered based on an ambiguity category, and then a distance between each candidate and the ambiguous term is computed based on corresponding vector representations. Candidates that are closest to the ambiguous term are used to generated the alternative queries.

A query can be ambiguous for a variety of reasons, including being phrased in a manner that the data analytics chatbot does not account for or referring to information that does not exist or is inaccessible to the data analytics chatbot, not clearly identifying a request for specific information, etc. For instance, a user might ask a data analytics chatbot, “What is the most yield last month?”. Here, the term “yield” is ambiguous, and conventional data analytics chatbots will not provide an accurate response.

Some data analytics chatbots use machine learning model trained to process user queries. However, it is challenging to train a machine learning model to have a level of semantic understanding that enables responding to ambiguous queries. For example, the term “yield” could refer to revenue, crop production, or even investment returns, depending on context. Without this context, a machine learning model is unable to generate an appropriate response.

Furthermore, since an ambiguous term can have multiple potential meanings, it may be necessary to generate a follow up question to resolve the ambiguity. For example, given the ambiguous query “What is the most yield last month?”, a potential clarifying question could be, “Are you asking about the highest revenue generated last month?” This question narrows the query to the revenue context, but still leaves room for ambiguity. For instance, the user might be interested in the highest revenue generated from a specific product or service, rather than an overall revenue. Data processing systems can ask a series of follow-up questions to resolve an ambiguous word in a query but it can be inefficient to exchange multiple rounds of questions and answers.

Accordingly, embodiments of the present disclosure include systems and methods that perform query disambiguation by identifying a set of candidate elements based on an ambiguous element in a query and replacing the ambiguous element with the set of candidate elements to obtain a set of modified queries. The set of candidate elements are identified and retrieved based on an ambiguity category and respective distances between the ambiguous element and the set of candidate elements. For example, the candidate terms can be retrieved from a database based on the ambiguity category. Each candidate term can be compared to the ambiguous term from the query to identify those candidates that are the most relevant.

By identifying the set of candidate elements based on the ambiguity category, embodiments of the disclosure reduce the set of potential candidate elements, which is more efficient than comparing the ambiguous term to every candidate term in a database. Furthermore, generating a set of modified queries by replacing the ambiguous element with the set of modified elements provides directly stated options to the user and helps to avoid multiple inefficient rounds of questions and answers to resolve an ambiguity of the query.

Therefore, the present disclosure provides an improvement over convention data analytics applications by enabling more efficient and accurate responses to ambiguous queries. Embodiments of the disclosure can be employed without difficult and expensive training of a machine learning model. Furthermore, an identify-and-replace query disambiguation algorithm described herein is more computationally efficient and less resource-intensive than conventional methods.

Accordingly, embodiments of the present disclosure perform a more efficient query disambiguation process to increase the accuracy of a data analytics chatbot system. Because the set of candidate elements are selected based on the distance between the candidate elements and the ambiguous element, the set of candidate elements are selected according to an objective standard that cannot be performed by a mental process within a timeframe that is practical for a user-interaction context. Therefore, the set of modified queries including the set of candidate elements are generated with an accuracy and efficiency that would not be possible but for the selection of the set of candidate elements based on the distances.

### Terminology Examples

A “query” refers to a text string. In one example, a query is provided by a user to a user interface by entering text into the user interface. In another example, the user provides a spoken language input to the user interface and the user interface transcribes the spoken language input to obtain the query.

An “ambiguous element” refers to an element (e.g., a character, word, or group of characters or words) of a query that is determined to be ambiguous. In some embodiments, an element is determined to be ambiguous according to an ambiguity metric (such as a dissimilarity between the element and a set of known elements, where a sufficiently dissimilar element is determined to be ambiguous). In some embodiments, a trained machine learning model determines whether an element is ambiguous, and/or determines an ambiguity category for the ambiguous element, based on the training of the machine learning model.

An “ambiguity category” refers to a type of ambiguity that an element can have. Examples of ambiguity categories include entity-level ambiguity (including metric-level ambiguity and dimension-level ambiguity), value-level ambiguity, and intent-level-ambiguity.

Some queries have well-formatted structures, but refer to metrics (elements that refer to numeric information, such as “sessions”, “orders”, “traffic”, “visitors”, “people”, “conversions”, etc.) and dimensions (elements that refer to grouped metrics or segments such as “gender”, “browsers”, “pages”, “countries”, etc.) in a free form that does not align with a structure of known data. For example, “What is the yield?” can be a valid query, but if the element “yield” does not match with an element stored in a database, the element “yield” corresponds to an entity-level ambiguity.

Sometimes, an element included in a query is identical to a known element, but is ambiguous regarding a value or precise information for the element. For instance, a query asking for “revenue” might not indicate whether the revenue is from last week, last month, or which organization. Therefore, the element “revenue” corresponds to a value-level ambiguity.

Finally, an intent of a user query can be ambiguous. For example, a query for “a view of frequent buyers across countries segment” can indicate a request to create a view or segment of frequent buyers, or can indicate a request for a visualization or graph of frequent buyers across different countries. Therefore, the element “a view of frequent buyers across countries segment” corresponds to an intent-level ambiguity.

A “distance” refers to a numerical distance between two elements. In some embodiments, the two elements are represented by embeddings, and the distance is computed between the two embeddings. An “embedding” refers to a representation of an object (e.g., an element) in a lower-dimensional space such that semantic information about the object is more easily captured and analyzed by a machine learning model. For example, the embedding is a numerical representation of the object in a continuous vector space in which objects that include similar semantic information to each other correspond to vectors that are numerically similar and thus “closer” to each other, thereby allowing a similarity between different objects corresponding to different embeddings to be readily determined.

An “element embedding” refers to an embedding of the element, e.g., a representation of the element in an embedding space. An “embedding space” (or a “vector space”) refers to a mathematical set having embeddings (or vectors) as components, and is characterized by a dimension specifying a number of independent directions in the embedding space.

An example of the present disclosure is used in a data analysis context. In the example, a user provides a query “Show me the yield in June” to a user interface of a data processing system. The data processing system determines that the element “yield” of the query is ambiguous and corresponds to a metrics-level ambiguity category. In response to the determination, the data processing system retrieves a set of potential candidate elements from a database, where the set of potential candidate elements are associated with the metrics-level ambiguity category.

The data processing system generates an embedding for the ambiguous element “yield” and each of the set of potential candidate elements, and computes a distance between the ambiguous element embedding and each of the set of potential candidate element embeddings, respectively. The data processing system determines based on the computation that embeddings of potential candidate elements “revenue”, “profit”, and “conversion rate” are least distant from the embedding of the ambiguous element “yield”, and therefore selects “revenue”, “profit”, and “conversion rate” as a set of candidate elements.

The data processing system generates a set of modified queries by replacing “yield” in the query with each of “revenue”, “profit”, and “conversion rate”. The data processing system generates a response including the set of modified queries, such as:
Did you mean:
   Show me the revenue in June
   Show me the profit in June
   Show me the conversion rate in June.
   None of the above.

The user interface displays the generated response to the user. The user selects one of the modified queries, or types at least one of the elements included in the set of modified queries, to provide a replacement query. The ambiguous query is then, therefore, disambiguated. The data processing system can then, for example, perform a search using the replacement query, or generate a response to the replacement query using a machine learning model, such as a large language model.

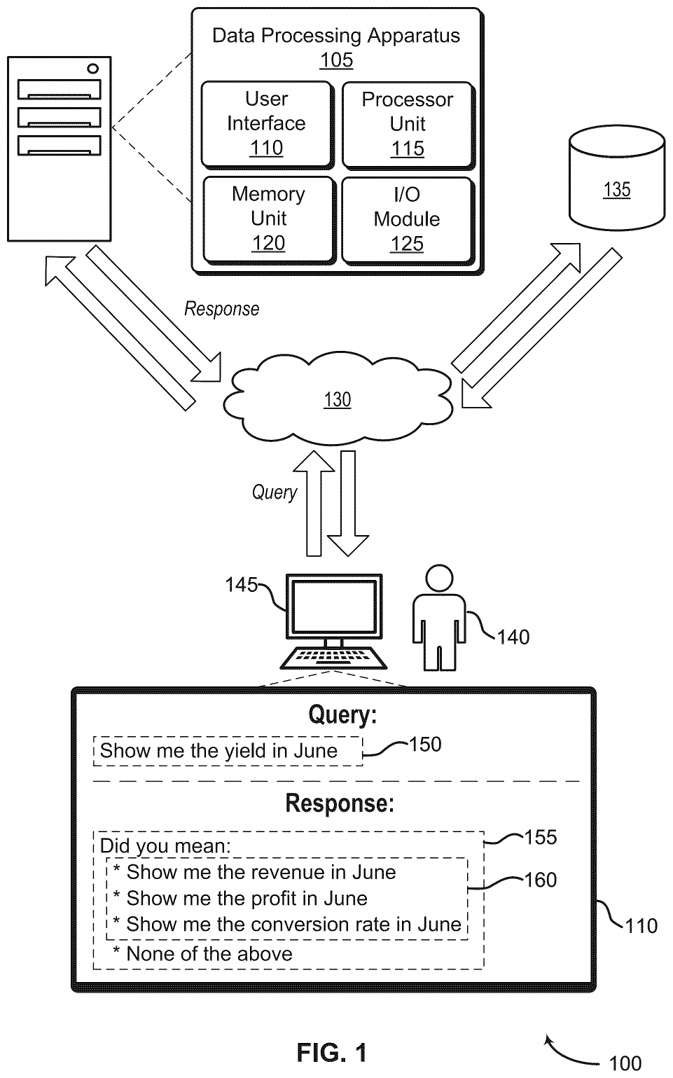

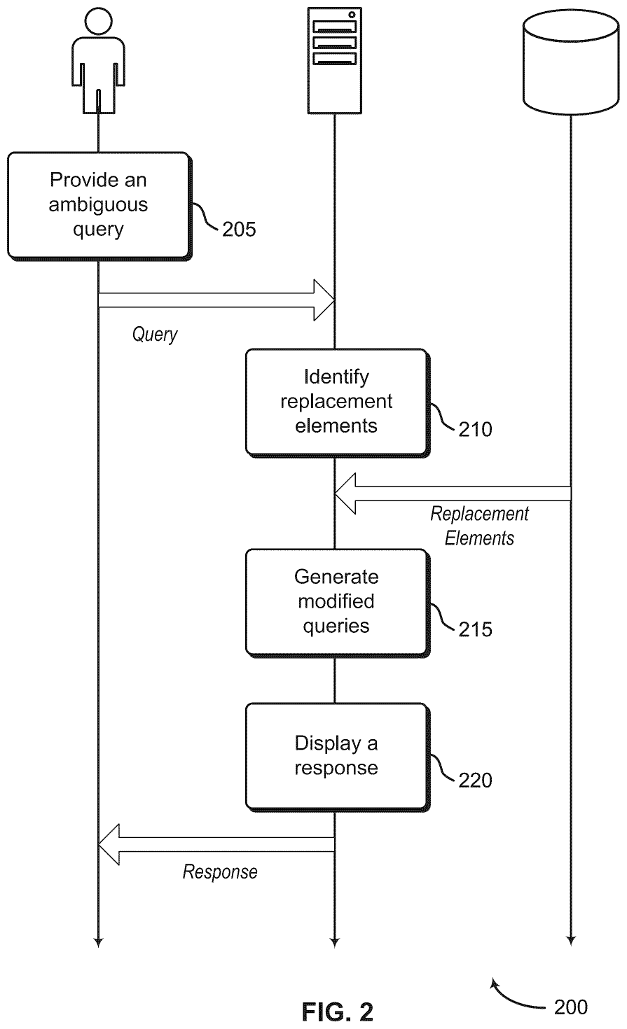

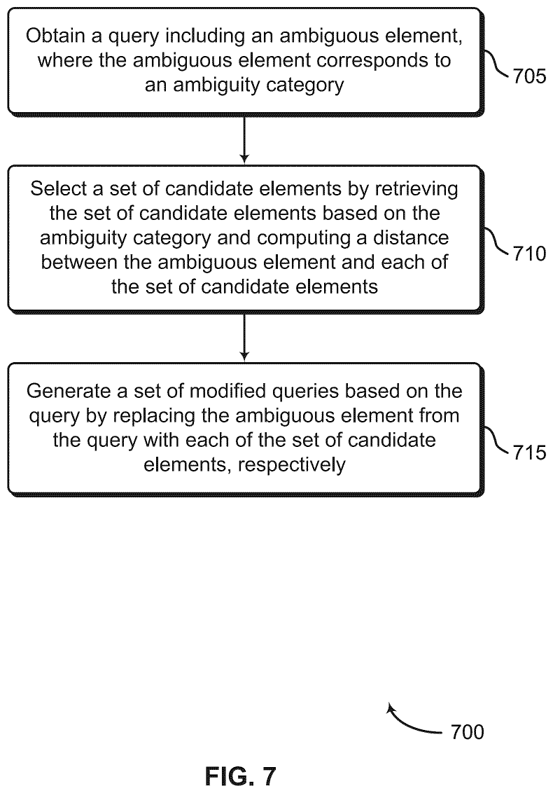

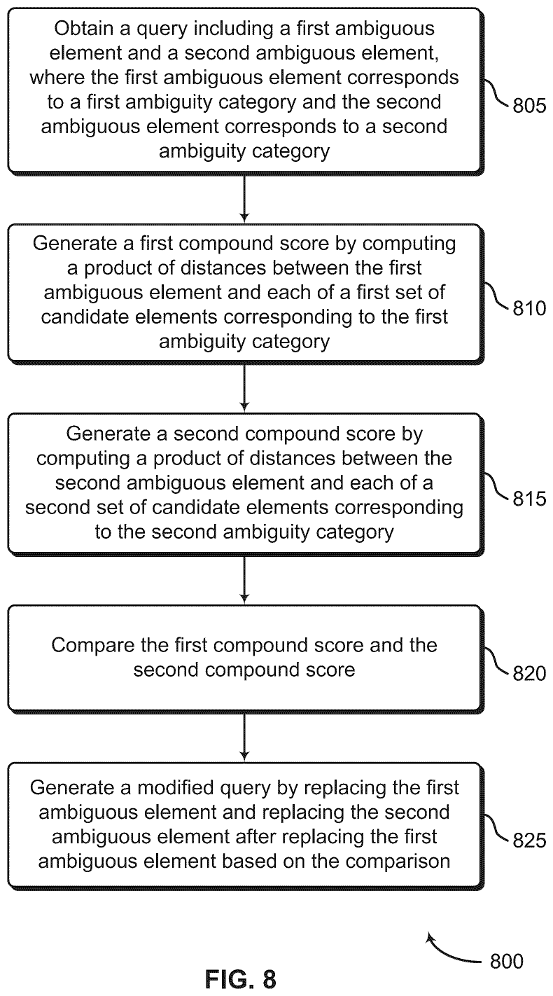

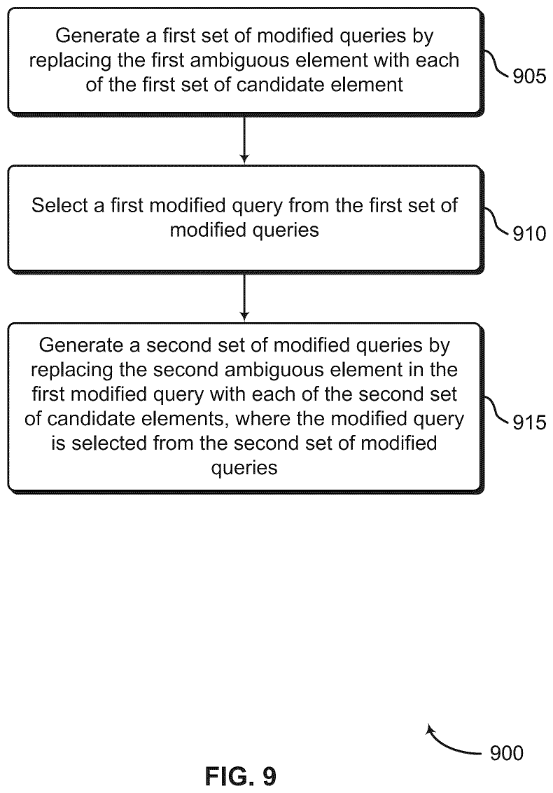

Further examples of the present disclosure in the data analysis context are provided with reference to FIGS. 1-2. Details regarding the architecture of the data processing system are provided with reference to FIGS. 1-6. Examples of a process for query disambiguation are provided with reference to FIGS. 2 and 7. Examples of a process for disambiguating a query including multiple ambiguous elements are described with reference to FIGS. 8-9.

### Data Processing System

FIG. 1 shows an example of a data processing system 100 that employs a query 150 disambiguation method according to aspects of the present disclosure. The example shown includes data processing system 100, user 140, user device 145, query 150, and response 155. In one aspect, response 155 includes set of modified queries 160. In one aspect, data processing system 100 includes data processing apparatus 105, cloud 130, and database 135. In one aspect, data processing apparatus 105 includes user interface 110, processor unit 115, memory unit 120, and I/O module 125.

In the example of FIG. 1, user interface 110 obtains a query (e.g., query 150) including an ambiguous element, where the ambiguous element corresponds to an ambiguity category. For example, query 150 (e.g., “Show me the yield in June”) includes an ambiguous element “yield” corresponding to a metrics-level ambiguity category. In some embodiments, user interface 110 is displayed by data processing apparatus 105 on a user device (e.g., user device 145), and a user (e.g., user 140) provides the query to user interface 110 via the user device.

Data processing apparatus 105 retrieves a set of candidate elements (e.g., “revenue”, “profit”, and “conversion rate”) from database 135 that most closely match the ambiguous element. In an example, data processing apparatus 105 retrieves a set of potential candidate elements from database 135, where each of the set of potential candidate elements is an element that is associated with the ambiguity category in database 135. Data processing apparatus 105 generates embeddings for the ambiguous element and each of the set of potential candidate elements.

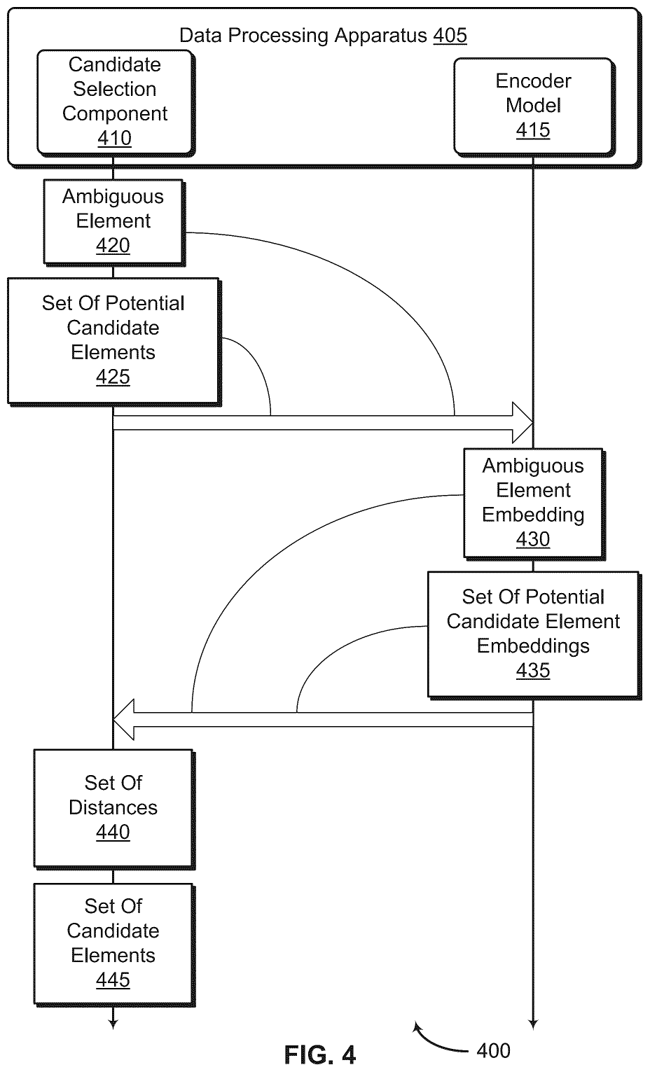

Data processing apparatus 105 identifies the set of candidate elements by comparing the ambiguous element embedding and each of the potential candidate element embeddings, determining the potential candidate element embeddings that are least distant from the ambiguous element embedding based on the comparisons, and identifying the potential candidate elements corresponding to the least-distant potential candidate element embeddings as the set of candidate elements. An example of a data processing apparatus that selects a set of candidate elements using a set of candidate element embeddings is described in further detail with reference to FIG. 4.

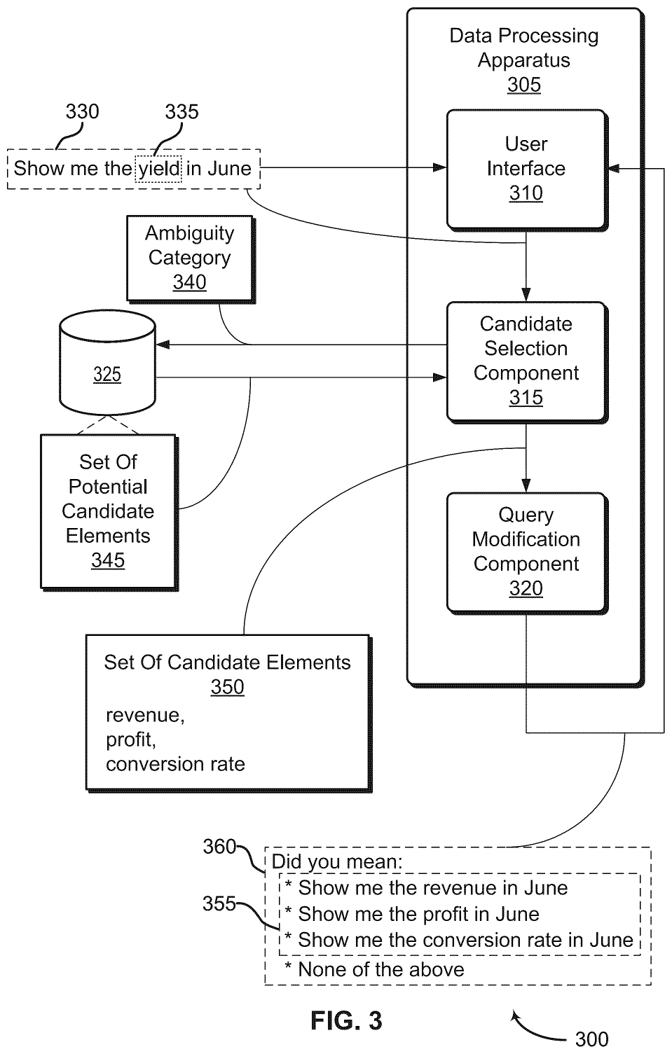

Data processing apparatus 105 generates a set of modified queries (e.g., set of modified queries 160) by replacing the ambiguous element in the query with each candidate element of the set of candidate elements. In some embodiments, data processing apparatus 105 generates a response (e.g., response 155) indicating the query includes the ambiguous element. User interface 110 displays the response along with the set of modified queries. An example of a data processing system that employs a query disambiguation method is described in further detail with reference to FIG. 3.

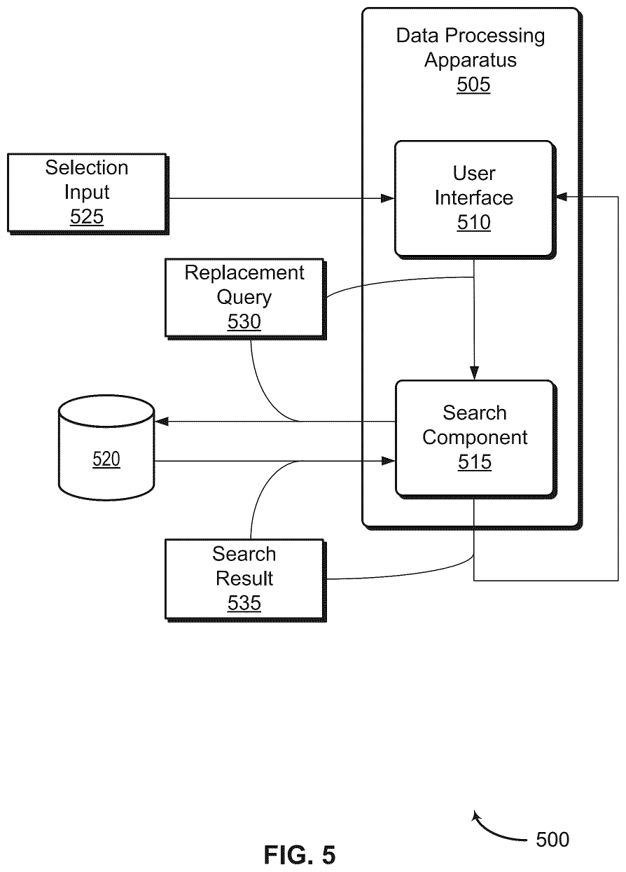

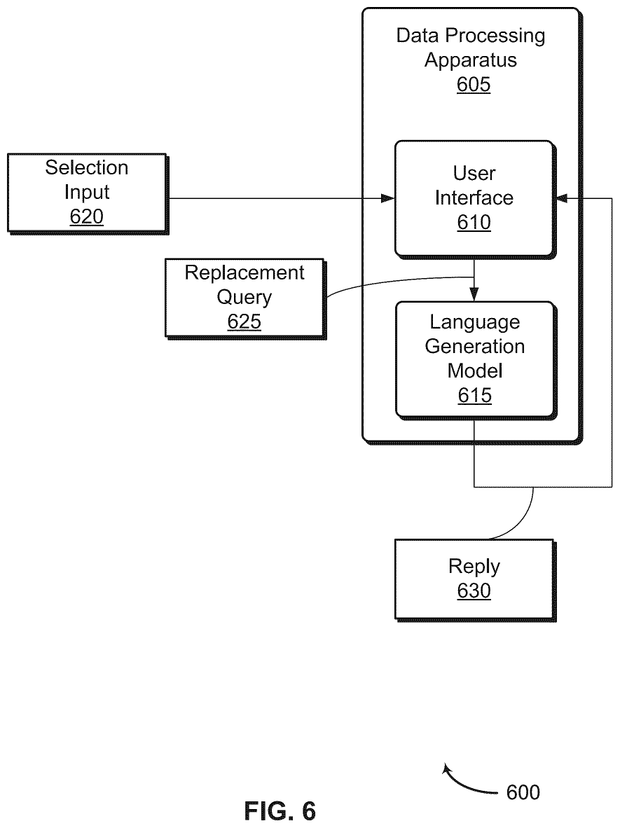

According to some aspects, user interface receives a selection input from the user to select a replacement query from the set of modified queries. In some embodiments, data processing apparatus 105 performs a search using the replacement query as described with reference to FIG. 5. In some embodiments, data processing apparatus 105 generates a reply to the replacement query using a language generation model as described with reference to FIG. 6.

According to some aspects, user interface 110 obtains a query including an ambiguous element and an additional ambiguous element, where the ambiguous element corresponds to an ambiguity category and the additional ambiguous element corresponds to an additional ambiguity category. An example query is “Show me the yield for my site”, where the ambiguous elements are “yield” and “my site”.

Data processing apparatus 105 retrieves a set of candidate elements for the ambiguous element and an additional set of candidate elements for the additional ambiguous element from database 135 based on similarities between embeddings of the ambiguous element and the set of candidate elements and of the additional ambiguous element and the additional set of candidate elements.

Data processing apparatus 105 determines an order to generate and display sets of modified queries for the ambiguous element and the additional ambiguous element based on a comparison of compound scores obtained by multiplying similarity scores for the set of candidate elements with each other and by multiplying similarity scores for the additional set of candidate elements with each other, respectively. For example, data processing apparatus 105 first generates and displays a first set of modified queries using a set of candidate elements associated with the “better” (either higher or lower) compound score that indicates a closer collective match with the corresponding ambiguous element. After receiving a user selection of a replacement query including a first candidate element for the first set of modified queries, data processing apparatus 105 generates a second set of modified queries including the first candidate element using the other set of candidate elements.

In an example, given the query “Show me the yield for my site”, data processing apparatus 105 determines that “revenue”, “profit”, and “conversion rate” are candidate elements for the ambiguous element “yield”, and that “a.com”, “b.com”, and “c.com” are candidate elements for the ambiguous element “my site”. Data processing apparatus 105 determines a compound score based on similarity scores for ambiguous element “yield” and candidate elements “revenue”, “profit”, and “conversion rate” and an additional compound score based on additional similarity scores for additional ambiguous element “my site” and additional candidate elements “a.com”, “b.com”, and “c.com”.

Data processing apparatus 105 determines that the additional compound score is better than the compound score, and therefore generates and displays a first set of modified queries “Show me the yield for a.com”, “Show me the yield for b.com,” and “Show me the yield for c.com” based on the set of additional candidate elements. Following a user selection of “Show me the yield for a.com” as a replacement query, data processing apparatus 105 generates a second set of modified queries, “Show me the revenue for a.com”, “Show me the profit for a.com”, and “Show me the conversion rate for a.com” based on the additional candidate element “a.com” and the set of candidate elements. An example of a method for generating a modified query by replacing a set of ambiguous elements of a query is described in further detail with respect to FIGS. 8-9.

Data processing system 100 and data processing apparatus 105 are examples of, or include aspects of, the corresponding elements described with reference to FIGS. 3-6. According to some aspects, data processing apparatus 105 includes a computer-implemented network. In some embodiments, data processing apparatus 105 also includes at least one processor, a memory subsystem, a communication interface, an I/O interface, at least one user interface component, and a bus. Additionally, in some embodiments, data processing apparatus 105 communicates with user device 145 and database 135 via cloud 130.

According to some aspects, data processing apparatus 105 is implemented on a server. A server provides at least one function to users linked by way of one or more of various networks, such as cloud 130. In some embodiments, the server includes a single microprocessor board, which includes a microprocessor responsible for controlling all aspects of the server. In some embodiments, the server uses microprocessor and protocols to exchange data with other devices or users on one or more of the networks via at least one protocol, such as hypertext transfer protocol (HTTP), simple mail transfer protocol (SMTP), file transfer protocol (FTP), simple network management protocol (SNMP), and the like.

According to some aspects, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

User interface 110 is an example of, or includes aspects of, the corresponding element described with reference to FIGS. 3, 5, and 6. According to some aspects, user interface 110 is implemented as software stored in memory unit 120 and executable by processor unit 115. According to some aspects, user interface 110 is a graphical user interface, a text-based interface, or a combination thereof. According to some aspects, user interface 110 is displayed on a user device by data processing apparatus 105.

Processor unit 115 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

Processor unit 115 is configured to execute computer-readable instructions stored in memory unit 120 to perform various functions. Processor unit 115 can be configured to operate a memory array using a memory controller. A memory controller can be integrated into processor unit 115. Processor unit 115 can include special purpose components for modem processing, baseband processing, digital signal processing, or transmission processing.

Memory unit 120 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 115 to perform various functions described herein.

In some embodiments, memory unit 120 includes a basic input/output system (BIOS) that controls basic hardware or software operations, such as an interaction with peripheral components or devices. Memory unit 120 can include a memory controller that operates memory cells of memory unit 120. For example, the memory controller can include a row decoder, column decoder, or both. In some embodiments, memory cells within memory unit 120 store information in the form of a logical state. I/O module 125 receives inputs from and transmits outputs of data processing apparatus 105 to other devices or users.

According to some aspects, data processing apparatus 105 uses one or more processors of processor unit 115 to execute instructions stored in memory unit 120 to perform functions described herein. In an example, the data processing apparatus 105 obtains a query including an ambiguous element, wherein the ambiguous element corresponds to an ambiguity category; selects a plurality of candidate elements by retrieving the plurality of candidate elements based on the ambiguity category and computing a distance between the ambiguous element and each of the plurality of candidate elements; and generates a plurality of modified queries by replacing the ambiguous element with each of the plurality of candidate elements, respectively.

Further detail regarding the architecture of data processing apparatus 105 is provided with reference to FIGS. 2-6. Further detail regarding a process for query disambiguation is provided with reference to FIGS. 2 and 7. Further detail regarding a process for query disambiguation for multiple ambiguous elements is provided with reference to FIGS. 8 and 9.

Cloud 130 is a computer network configured to provide on-demand availability of computer system resources, such as data storage and computing power. In some examples, cloud 130 provides resources without active management by a user. The term “cloud” is sometimes used to describe data centers available to many users over the Internet.

Some large cloud networks have functions distributed over multiple locations from central servers. A server is designated an edge server if it has a direct or close connection to a user. In some examples, cloud 130 is limited to a single organization. In other examples, cloud 130 is available to many organizations.

In one example, cloud 130 includes a multi-layer communications network comprising multiple edge routers and core routers. In another example, cloud 130 is based on a local collection of switches in a single physical location. According to some aspects, cloud 130 provides communications between data processing apparatus 105, database 135, and user device 145.

Database 135 is an example of, or includes aspects of, the corresponding element described with reference to FIGS. 3 and 5. A database is an organized collection of data. In an example, database 135 stores data in a specified format known as a schema. Database 135 is structured as a single database, a distributed database, multiple distributed databases, or an emergency backup database. Data storage and processing in database 135 is manageable by a database controller, which can be operated by a user or automatically without interaction from the user. In some examples, database 135 is external to data processing apparatus 105 and communicates with data processing apparatus 105 via cloud 130. In other examples, database 135 is included in data processing apparatus 105.

According to some aspects, user device 145 is a personal computer, laptop computer, mainframe computer, palmtop computer, personal assistant, mobile device, or any other suitable processing apparatus. In some embodiments, user device 145 includes software that displays user interface 110. User interface 110 allows information to be communicated between user 140 and data processing apparatus 105.

According to some aspects, a user device user interface enables user 140 to interact with user device 145. In some embodiments, the user device user interface includes an audio device, such as an external speaker system, an external display device such as a display screen, or an input device (e.g., a remote-control device interfaced with the user interface directly or through an I/O controller module). In some embodiments, the user device user interface is a graphical user interface.

Query 150, response 155, and set of modified queries 160 are examples of, or includes aspects of, the corresponding elements described with reference to FIG. 3.

FIG. 2 shows an example of a method 200 for generating a set of modified queries using a disambiguation method according to aspects of the present disclosure. Referring to FIG. 2, an aspect of the present disclosure is used in a data analysis context. In an example, a user provides a query including an ambiguous element to a user interface of a data processing system. The data processing system identifies replacement elements for the ambiguous element by computing distances between the ambiguous element and a set of elements stored in a database, and retrieving the closest elements from the database. The data processing system generates a set of modified queries by replacing the ambiguous element with each of the retrieved replacement elements. The data processing system displays a response including the set of modified queries.

At operation 205, a user provides an ambiguous query. In some cases, the operations of this step refer to, or are performed by, a user as described with reference to FIG. 1. In one example, a query is provided by a user to a user interface by entering text into the user interface. In another example, the user provides a spoken language input to the user interface and the user interface transcribes the spoken language input to obtain the query. The query includes an ambiguous element.

At operation 210, the system identifies replacement elements. In some cases, the operations of this step refer to, or are performed by, a data processing apparatus as described with reference to FIGS. 1 and 3-6. In an example, the data processing apparatus determines a set of replacement elements for the ambiguous element based on distances between the set of replacement elements and the ambiguous element as described with reference to FIGS. 3-4.

At operation 215, the system generates modified queries. In some cases, the operations of this step refer to, or are performed by, a data processing apparatus as described with reference to FIGS. 1 and 3-6. In an example, the data processing apparatus generates a set of modified queries by replacing the ambiguous element with each of the set of replacement elements as described with reference to FIG. 3.

At operation 220, the system displays a response. In some cases, the operations of this step refer to, or are performed by, a data processing apparatus as described with reference to FIGS. 1 and 3-6. In an example, the data processing apparatus displays a response including the set of modified queries as described with reference to FIG. 3.

FIG. 3 shows an example of a data processing system 300 that employs a query disambiguation method according to aspects of the present disclosure. The example shown includes data processing system 300, query 330, ambiguity category 340, set of potential candidate elements 345, set of candidate elements 350, and response 360. In one aspect, data processing system 300 includes data processing apparatus 305 and database 325. In one aspect, data processing apparatus 305 includes user interface 310, candidate selection component 315, and query modification component 320.

Referring to FIG. 3, user interface 310 obtains a query (e.g., query 330) including an ambiguous element (e.g., ambiguous element 335), where the ambiguous element corresponds to ambiguity category 340. In the example of FIG. 3, query 330, “Show me the yield in June”, includes ambiguous element 335, “yield”, corresponding to a “metrics” ambiguity category.

According to some aspects, candidate selection component 315 detects one or more ambiguous elements in the query. In some embodiments, candidate selection component 315 computes an ambiguity score for the ambiguous element(s) and detects the ambiguous element(s) based on the ambiguity score(s).

In an example, candidate selection component 315 identifies an element in the query. Candidate selection component 315 identifies ambiguity category 340 for the element. Candidate selection component 315 generates an element embedding based on the element (for example, using an encoder model such as the encoder model 415 described with reference to FIG. 4). Candidate selection component 315 retrieves set of potential candidate elements 345 corresponding to ambiguity category 340 from database 325.

Candidate selection component 315 generates a set of potential candidate element embeddings based on set of potential candidate elements 345 (for example, using the encoder model). Candidate selection component 315 determines the ambiguity score by computing a distance between the element embedding and a closest potential candidate element embedding of the set of potential candidate element embeddings. Candidate selection component 315 determines that the ambiguity score exceeds an ambiguity threshold, and identifies the element as an ambiguous element based on the determination that the ambiguity score exceeds an ambiguity threshold.

According to some aspects, data processing apparatus 305 identifies a user profile associated with the query, where the set of potential candidate elements 345 are retrieved based on the user profile. In an example, candidate selection component 315 determines that an ambiguous element of a query relates to the user profile. Candidate selection component 315 retrieves set of potential candidate elements 345 based on an association between the user profile and elements of the set of potential candidate elements 345 in database 325. For example, for a query “show me the revenue for my site”, candidate selection component 315 determines that “my site” is an ambiguous element because the user profile is associated with multiple different sites. Candidate selection component 315 retrieves a set of potential candidate elements that relate to the user profile (e.g., elements “a.com”, “b.com”, “c.com”, etc.).

The candidate selection component obtains a set of candidate elements (e.g., set of candidate elements 350) by computing distances between the embedding of the ambiguous element and each of the set of potential candidate elements and selecting the potential candidate elements associated with the least distant potential candidate embeddings as described with reference to FIG. 4. In the example of FIG. 3, set of potential candidate elements 350 includes elements “revenue”, “profit”, and “conversion rate” that most closely match the ambiguous element “yield” among set of potential candidate elements 345. In some aspects, the set of candidate elements includes at least three candidate elements.

According to some aspects, query modification component 320 generates a set of modified queries (e.g., set of modified queries 355) by replacing the ambiguous element in the query with each of the set of candidate elements, respectively. In the example of FIG. 3, query modification component 320 generates modified queries 355, “Show me the revenue in June”, “Show me the profit in June”, and “Show me the conversion rate in June”, by replacing “yield” in the query “Show me the yield in June” with each of “revenue”, “profit”, and “conversion rate”. In some embodiments, data processing apparatus 305 generates a response (e.g., response 360) indicating the query includes the ambiguous element. In the example of FIG. 3, response 360 includes text “Did you mean:” indicating that query 330 includes an ambiguous element. User interface 310 displays the response along with the set of modified queries.

According to some aspects, query modification component 320 generates sets of modified queries by respectively replacing multiple ambiguous elements in the query with each of sets of candidate elements, respectively, where the sets of modified queries are generated and displayed in an order corresponding to compound scores for the sets of modified queries. For example, query modification component 320 compares a compound score and an additional compound score, and generates a set of modified queries by replacing an additional ambiguous element with each of a set of additional candidate elements after replacing an ambiguous element with each of a set of candidate elements based on the comparison. The candidate selection component determines the compound scores as described with reference to FIG. 4.

In an example, given a query “Show me the yield in June for my site”, where both “yield” and “my site” are ambiguous elements associated with respective sets of candidate elements, and “yield” is associated with a better (e.g., smaller) compound score than “my site”, query modification component 320 first generates modified queries “Show me the revenue in June for my site”, “Show me the profit in June for my site”, and “Show me the conversion rate in June for my site” by replacing “yield” in the query “Show me the yield in June for my site” with each of “revenue”, “profit”, and “conversion rate”.

After “Show me the profit in June for my site” is selected as a replacement query, query modification component then generates queries “Show me the profit in June for a.com”, “Show me the profit in June for b.com”, and “Show me the profit in June for c.com” by replacing “my site” in the replacement query with each of “a.com”, “b.com”, and “c.com”. A user may then provide an additional selection input to user interface 310 to select an additional replacement query.

Data processing system 300 and data processing apparatus 305 are examples of, or include aspects of, the corresponding elements described with reference to FIGS. 1 and 4-6. User interface 310 is an example of, or includes aspects of, the corresponding element described with reference to FIGS. 1, 5, and 6.

Candidate selection component 315 is an example of, or includes aspects of, the corresponding element described with reference to FIG. 4. In some embodiments, candidate selection component 315 is implemented as software stored in a memory unit (such as the memory unit 120 described with reference to FIG. 1) and executable by a processor unit (such as the processor unit 115 described with reference to FIG. 1), as firmware, as at least one hardware circuit, or as a combination thereof.

According to some aspects, candidate selection component 315 comprises machine learning parameters stored in the memory unit. Machine learning parameters, also known as model parameters or weights, are variables that provide a behavior and characteristics of a machine learning model. Machine learning parameters are learned or estimated from training data and are used to make predictions or perform tasks based on learned patterns and relationships in the data.

Machine learning parameters are adjusted during a training process to minimize a loss function or maximize a performance metric. A goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Artificial neural networks (ANNs) have numerous parameters, including weights and biases associated with each neuron in the network, which control a degree of connections between neurons and influence the ANN's ability to capture complex patterns in data.

An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, the node processes the signal and then transmits the processed signal to other connected nodes.

The signals between nodes comprise real numbers, and the output of each node is computed by a function of the sum of the inputs of each node. Nodes determine the output using other mathematical algorithms, such as selecting the max from the inputs as the output, or any other suitable algorithm for activating the node. Each node and edge are associated with at least one node weight that determines how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to increase the accuracy of the result (e.g., by minimizing a loss which corresponds in some way to the difference between the current result and the target result). The weight of an edge increases or decreases the strength of the signal transmitted between nodes. Nodes have a threshold below which a signal is not transmitted at all. In some examples, the nodes are aggregated into layers. Different layers perform different transformations on their inputs. The initial layer is known as the input layer and the last layer is known as the output layer. In some examples, signals traverse certain layers multiple times.

In some embodiments, candidate selection component 315 comprises one or more ANNs trained to detect an element in a query and to identify an ambiguity category for the element. In an example, candidate selection component 315 comprises a classifier network comprising one or more feed-forward neural networks. In another example, candidate selection component 315 comprises a large language model. In some examples, a large language model comprises one or more ANNs trained to understand and generate human-like text based on large amounts of data. In some examples, by analyzing input text data, a large language model learns patterns and structures of human language. In some examples, the large language model includes one or more transformers.

According to some aspects, a transformer comprises one or more ANNs comprising attention mechanisms that enable the transformer to weigh an importance of different words or tokens within a sequence. In some examples, a transformer processes entire sequences simultaneously in parallel, making the transformer highly efficient and allowing the transformer to capture long-range dependencies more effectively.

According to some aspects, a transformer comprises an encoder-decoder structure. The encoder of the transformer processes an input sequence and encodes the input sequence into a set of high-dimensional representations. The decoder of the transformer generates an output sequence based on the encoded representations and previously generated tokens. The encoder and the decoder each include one or more layers of self-attention mechanisms and feed-forward ANNs.

The self-attention mechanism allows the transformer to focus on different parts of an input sequence while computing representations for the input sequence. The self-attention mechanism captures relationships between words of a sequence by assigning attention weights to each word based on a relevance to other words in the sequence, thereby enabling the transformer to model dependencies regardless of a distance between words.

An attention mechanism is a key component in some ANN architectures, particularly ANNs employed in natural language processing (NLP) and sequence-to-sequence tasks, which allows an ANN to focus on different parts of an input sequence when making predictions or generating output. Some sequence models process an input sequence sequentially, maintaining an internal hidden state that captures information from previous steps. However, this sequential processing can lead to difficulties in capturing long-range dependencies or attending to specific parts of the input sequence. The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

According to some aspects, an ANN employing an attention mechanism receives an input sequence and maintains the current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN. By incorporating an attention mechanism, an ANN dynamically allocates attention to different parts of the input sequence, allowing the ANN to focus on relevant information and capture dependencies across longer distances.

According to some aspects, candidate selection component comprises an encoder model (e.g., the encoder model 415 described with reference to FIG. 4) comprising one or more ANNs trained to generate an embedding of a text input. In an example, the encoder model comprises an encoder of a transformer.

According to some aspects, query modification component 320 is implemented as software stored in the memory unit and executable by the processor unit, as firmware, as at least one hardware circuit, or as a combination thereof.

Database 325 is an example of, or includes aspects of, the corresponding element described with reference to FIGS. 1 and 5. Query 330, response 360, and set of modified queries 355 are examples of, or includes aspects of, the corresponding elements described with reference to FIG. 1. Ambiguous element 335 and set of candidate elements 350 are examples of, or include aspects of, the corresponding elements described with reference to FIG. 4.

FIG. 4 shows an example of a data processing apparatus that selects a set of candidate elements using a set of candidate element embeddings according to aspects of the present disclosure. The example shown includes data processing system 400, ambiguous element 420, set of potential candidate elements 425, ambiguous element embedding 430, set of potential candidate element embeddings 435, set of distances 440, and set of candidate elements 445. In one aspect, data processing system 400 includes data processing apparatus 405. In one aspect, data processing apparatus 405 includes candidate selection component 410 and encoder model 415. In one aspect, candidate selection component 410 includes encoder model 415.

Referring to FIG. 4, candidate selection component 410 provides ambiguous element 420 and set of potential candidate elements 425 to encoder model 415. Encoder model 415 encodes the ambiguous element 420 to obtain ambiguous element embedding 430 and encodes each set of potential candidate elements 425 to obtain set of potential candidate element embeddings 435, respectively.

Candidate selection component 410 computes set of distances 440 including distances between ambiguous element embedding 430 and each of set of potential candidate element embeddings 435. Candidate selection component 410 selects set of candidate elements 445 from among set of potential candidate elements 425 by identifying potential candidate elements that are associated with potential candidate element embeddings that are least distant from ambiguous element embedding 430. In an example, for a query “Show me the yield in June” including an ambiguous element “yield”, candidate selection component 410 identifies “revenue”, “profit”, and “conversion rate” from among a set of potential candidate elements as the set of candidate elements, where an embedding for “revenue” is associated with an embedding that is closest to an embedding for “yield”, an embedding for “profit” is associated with an embedding that is next closest to the embedding for “yield”, and an embedding for “conversion rate” is third closest to the embedding for “yield”.

According to some aspects, where a query includes multiple ambiguous elements, candidate selection component 410 generates a compound score for each ambiguous element. In an example, candidate selection component 410 identifies a set of candidate elements for an ambiguous element of the query and computes a product of distances between the embedding of the ambiguous element and the embeddings of each of the set of candidate elements for the ambiguous element with each other to determine the compound score.

For example, where distances between the ambiguous element embedding and embeddings for the set of candidate elements are 0.01, 0.02, and 0.03, respectively, the compound score is 0.01×0.02×0.03=0.000006. Candidate selection component 410 likewise determines a compound score for each additional ambiguous element included in the query. Data processing apparatus 405 generates and displays sets of replacement queries for each ambiguous element of the query in order of compound score, from best to worst (e.g., lowest to highest), as described with reference to FIG. 3.

Data processing system 400 and data processing apparatus 405 are examples of, or include aspects of, the corresponding elements described with reference to FIGS. 1, 3, 5, and 6. Candidate selection component 410 is an example of, or includes aspects of, the corresponding element described with reference to FIG. 3. Ambiguous element 420, set of potential candidate elements 425, and set of candidate elements 445 are examples of, or include aspects of, the corresponding elements described with reference to FIG. 3.

FIG. 5 shows an example of a data processing apparatus 505 that performs a search based on a modified query according to aspects of the present disclosure. The example shown includes data processing system 500, selection input 525, replacement query 530, and search result 535. In one aspect, data processing system 500 includes data processing apparatus 505 and database 520. In one aspect, data processing apparatus 505 includes user interface 510 and search component 515.

Referring to FIG. 5, according to some aspects, user interface 510 receives selection input 525 selecting replacement query 530. In an example, user interface 510 displays modified queries “Show me the revenue in June”, “Show me the profit in June”, and “Show me the conversion rate in June”. A user provides selection input 525 to identify “Show me the revenue in June” as replacement query 530 by clicking on “Show me the revenue in June”, or by entering “revenue” or “Show me the revenue in June” in a text entry box of user interface 510.

Search component 515 performs a search based on replacement query 530 (for example, by searching using replacement query 530 among data stored in database 520 or among another data source, such as the Internet). Search component 515 retrieves search result 535 based on the search. User interface 510 displays search result 535.

Data processing system 500 and data processing apparatus 505 are examples of, or include aspects of, the corresponding elements described with reference to FIGS. 1, 3, 4, and 6. User interface 510 is an example of, or includes aspects of, the corresponding element described with reference to FIGS. 1, 3, and 6. According to some aspects, search component 515 is implemented as stored in a memory unit (such as the memory unit 120 described with reference to FIG. 1) and executable by a processor unit (such as the processor unit 115 described with reference to FIG. 1), as firmware, as at least one hardware circuit, or as a combination thereof. Database 520 is an example of, or includes aspects of, the corresponding element described with reference to FIGS. 1 and 3. Selection input 525 and replacement query 530 are examples of, or include aspects of, the corresponding elements described with reference to FIG. 6.

FIG. 6 shows an example of a data processing apparatus 605 that generates a reply 630 to a query according to aspects of the present disclosure. The example shown includes data processing system 600, selection input 620, replacement query 625, and reply 630. In one aspect, data processing system 600 includes data processing apparatus 605. In one aspect, data processing apparatus 605 includes user interface 610 and language generation model 615.

Referring to FIG. 6, according to some aspects, user interface 610 receives selection input 620 corresponding to replacement query 625. In an example, user interface 610 displays modified queries “Show me the revenue in June”, “Show me the profit in June”, and “Show me the conversion rate in June”. A user provides selection input 620 to identify “Show me the revenue in June” as replacement query 625 by clicking on “Show me the revenue in June”, or by entering “revenue” or “Show me the revenue in June” in a text entry box of user interface 610. Language generation model 615 generates reply 630 based on replacement query 625, where reply 630 includes text. User interface 610 displays reply 630.

Data processing system 600 and data processing apparatus 605 are examples of, or include aspects of, the corresponding elements described with reference to FIGS. 1 and 3-5. User interface 610 is an example of, or includes aspects of, the corresponding element described with reference to FIGS. 1, 3, and 5.

According to some aspects, language generation model 615 is implemented as software stored in a memory unit (such as the memory unit 120 described with reference to FIG. 1) and executable by a processor unit (such as the processor unit 115 described with reference to FIG. 1), as firmware, as at least one hardware circuit, or as a combination thereof. According to some aspects, language generation model 615 comprises language generation parameters (e.g., machine learning parameters) stored in the memory unit. In some embodiments, language generation model 615 comprises a large language model (LLM) comprising one or more transformers. An LLM is a machine learning model trained on a large dataset to generate text based on data inputs.

Selection input 620 and replacement query 625 are examples of, or include aspects of, the corresponding elements described with reference to FIG. 5.

Accordingly, a system and an apparatus for query disambiguation are described. One or more aspects of the system and apparatus include at least one processor; at least one memory, the at least one memory storing instructions executable by the at least one processor; a candidate selection component configured to select a plurality of candidate elements by retrieving the plurality of candidate elements based on an ambiguity category and computing a distance between an ambiguous element of a query and each of the plurality of candidate elements, wherein the ambiguous element corresponds to the ambiguity category; and a query modification component configured to generate a plurality of modified queries by replacing the ambiguous element with each of the plurality of candidate elements, respectively, based on the ambiguity category.

Some examples of the system and apparatus further include an encoder model configured to encode the ambiguous element to obtain an ambiguous element embedding. Some examples of the system and apparatus further include a user interface configured to receive the query and to display the plurality of modified queries. Some examples of the system and apparatus further include a search component configured to perform a search based on at least one of the plurality of modified queries. Some examples of the system and apparatus further include a language generation model trained to generate a reply to the query.

### Query Disambiguation

FIG. 7 shows an example of a method 700 for generating a set of modified queries according to aspects of the present disclosure. Referring to FIG. 7, user queries that are provided to data analytics chatbots may be ambiguous. In such a case, it is helpful to resolve the ambiguity so that the data analytics chatbot can provide a more accurate response to the query.

A query can be ambiguous for a variety of reasons, including being phrased in a manner that the data analytics chatbot does not account for or referring to information that does not exist or is inaccessible to the data analytics chatbot, not clearly identifying a request for specific information, etc. For instance, a user might ask a data analytics chatbot, “What is the most yield last month?”, where the term “yield” is ambiguous.

Some data analytics chatbots use machine learning model trained to process user queries. However, it is challenging to train a machine learning model to have a level of semantic understanding that enables responding to ambiguous queries. For example, the term “yield” could refer to revenue, crop production, or even investment returns, depending on context. Without this context, a machine learning model is unable to generate an appropriate response.

Furthermore, since an ambiguous term can have multiple potential meanings, it may be necessary to generate a follow up question to resolve the ambiguity. For example, given the ambiguous query “What is the most yield last month?”, a potential clarifying question could be, “Are you asking about the highest revenue generated last month?” This question narrows the query to the revenue context, but still leaves room for ambiguity. For instance, the user might be interested in the highest revenue generated from a specific product or service, rather than an overall revenue. Data processing systems can ask a series of follow-up questions to resolve an ambiguous word in a query but it can be inefficient to exchange multiple rounds of questions and answers.

Accordingly, embodiments of the present disclosure include systems and methods that perform query disambiguation by identifying a set of candidate elements based on an ambiguous element in a query and replacing the ambiguous element with the set of candidate elements to obtain a set of modified queries. The set of candidate elements are identified and retrieved based on an ambiguity category and respective distances between the ambiguous element and the set of candidate elements. For example, the candidate terms can be retrieved from a database based on the ambiguity category. Each candidate term can be compared to the ambiguous term from the query to identify those candidates that are the most relevant.

By identifying the set of candidate elements based on the ambiguity category, embodiments of the disclosure reduce the set of potential candidate elements, which is more efficient than comparing the ambiguous term to every candidate term in a database. Furthermore, generating a set of modified queries by replacing the ambiguous element with the set of modified elements provides directly stated options to the user and helps to avoid multiple inefficient rounds of questions and answers to resolve an ambiguity of the query.

At operation 705, the system obtains a query including an ambiguous element, where the ambiguous element corresponds to an ambiguity category. In some cases, the operations of this step refer to, or are performed by, a user interface of a data processing apparatus as described with reference to FIGS. 1, 3, 5, and 6. For example, a user provides the query to the user interface as described with reference to FIG. 3. The data processing apparatus identifies the ambiguous element and the ambiguity category as described with reference to FIG. 3. In an example, the data processing apparatus computes an ambiguity score for the ambiguous element and detects the ambiguous element based on the ambiguity score. In an example, the data processing apparatus identifies the ambiguity category based on an association between the identified ambiguous element and the ambiguity category (e.g., an association stored in a database).

At operation 710, the system selects a set of candidate elements by retrieving the set of candidate elements based on the ambiguity category and computing a distance between the ambiguous element and each of the set of candidate elements. In some cases, the operations of this step refer to, or are performed by, a candidate selection component as described with reference to FIGS. 3 and 4. For example, the candidate selection component selects the set of candidate elements as described with reference to FIGS. 3 and 4.

In an example, the candidate selection component retrieves a set of potential candidate elements corresponding to the ambiguity category from the database. In some embodiments, the set of potential candidate elements also include elements that relate to user profile information associated with the user. The candidate selection component encodes the ambiguous element to obtain an ambiguous element embedding and encodes each of the set of potential candidate elements to obtain a set of potential candidate element embeddings.

The candidate selection component computes a distance between the ambiguous element embedding and each of the set of potential candidate element embeddings. The candidate selection component selects the potential candidate elements associated with the potential candidate element embeddings that are least distant from the ambiguous element embedding as the set of candidate element embeddings. In some embodiments, the set of candidate elements includes at least three element embeddings, but in other embodiments, the set of candidate elements includes one or more candidate elements.

In another example, the data processing apparatus identifies an additional ambiguous element in the query and selects a set of additional candidate elements based on the additional ambiguous element by embedding the additional ambiguous element and a set of additional potential candidate elements and computing distances between the additional ambiguous element embedding and the set of additional potential candidate element embeddings.

The candidate selection component generates a compound score by computing a product of the distances between the ambiguous element embedding and each of the set of candidate element embeddings, and generates an additional compound score by computing a product of the distances between the additional ambiguous element embedding and each of the set of additional candidate element embeddings.

At operation 715, the system generates a set of modified queries based on the query by replacing the ambiguous element from the query with each of the set of candidate elements, respectively. In some cases, the operations of this step refer to, or are performed by, a query modification component as described with reference to FIG. 3. For example, the query modification component generates the set of modified queries as described with reference to FIG. 3.

In an example, the query modification component generates a response including the set of modified queries. The user interface displays the response. A user provides a selection input to the user interface to select one of the modified queries as a replacement query (e.g., by clicking on the modified query, by typing the modified query into the user interface, by typing the candidate element included in the modified query into the user interface, etc.). The data processing apparatus can perform a search based on the replacement query, as described with reference to FIG. 5, or generate a response to the replacement query using a machine learning model, as described with reference to FIG. 6.

In another example, the query modification component compares the compound score and the additional compound score. The query modification component determines that the compound score is better than the additional compound score based on the comparison (e.g., indicates a closer match to an associated set of candidate elements) and generates a first set of modified queries by replacing the ambiguous element with the with each of the set of candidate elements. The user selects one of the first set of modified queries as a replacement query.

The query modification component then generates a second set of modified queries by replacing the additional ambiguous element in the replacement query with each of the set of additional candidate elements. The user selects one of the second set of modified queries as a second replacement query. The data processing apparatus can perform a search based on the second replacement query, as described with reference to FIG. 5, or generate a response to the second replacement query using a machine learning model, as described with reference to FIG. 6.

Accordingly, a method for query disambiguation is described. One or more aspects of the method include obtaining a query including an ambiguous element, wherein the ambiguous element corresponds to an ambiguity category; selecting a plurality of candidate elements by retrieving the plurality of candidate elements based on the ambiguity category and computing a distance between the ambiguous element and each of the plurality of candidate elements; and generating a plurality of modified queries based on the query by replacing the ambiguous element from the query with each of the plurality of candidate elements, respectively. In some aspects, the plurality of candidate elements includes at least three candidate elements.

Some examples of the method further include computing an ambiguity score for the ambiguous element. Some examples further include detecting the ambiguous element based on the ambiguity score. Some examples of the method further include retrieving a plurality of potential candidate elements corresponding to the ambiguity category, wherein the plurality candidate elements are selected from the plurality of potential candidate elements. Some examples of the method further include identifying a user profile, wherein the plurality of candidate elements are selected based on the user profile.

Some examples of the method further include encoding the ambiguous element to obtain an ambiguous element embedding. Some examples further include encoding each of the plurality of candidate elements to obtain a plurality of candidate element embeddings, wherein the distances between the ambiguous element and each of the plurality of candidate elements are computed based on the ambiguous element embedding and the plurality of candidate element embeddings.

Some examples of the method further include displaying each of the plurality of modified queries. Some examples further include receiving a selection input corresponding to a replacement query of the plurality of modified queries. Some examples of the method further include generating a response indicating the query includes the ambiguous element. Some examples further include displaying the response along with the plurality of modified queries.

Some examples of the method further include selecting a replacement query from the plurality of modified queries. Some examples further include performing a search based on the replacement query. Some examples of the method further include retrieving a search result based on the search. Some examples further include displaying the search result in response to the replacement query.

Some examples of the method further include generating a compound score by computing a product of the distances between the ambiguous element and each of the plurality of candidate elements, wherein the plurality of modified queries are generated at least in part on the compound score. Some examples of the method further include identifying an additional ambiguous element in the query. Some examples further include selecting a plurality of additional candidate elements based on the additional ambiguous element.

Some examples further include generating an additional compound score corresponding to the additional ambiguous element based on the plurality of additional candidate elements. Some examples of the method further include comparing the compound score and the additional compound score, wherein the plurality of modified queries are generated by replacing the additional ambiguous element with each of the plurality of additional candidate elements after replacing the ambiguous element with each of the plurality of candidate elements based on the comparison.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Query Disambiguation for Multiple Ambiguous Elements

FIG. 8 shows an example of a method 800 for generating a modified query by replacing a set of ambiguous elements of a query according to aspects of the present disclosure. Referring to FIG. 8, some embodiments of the present disclosure employ a greedy algorithm based on compound scores to resolve multiple ambiguous elements included in a query. The greedy algorithm allows the multiple ambiguities to be accurately and efficiently handled in a single user interaction.

At operation 805, the system obtains a query including a first ambiguous element and a second ambiguous element, where the first ambiguous element corresponds to a first ambiguity category and the second ambiguous element corresponds to a second ambiguity category. In some cases, the operations of this step refer to, or are performed by, a user interface as described with reference to FIGS. 1, 3, 5, and 6. In an example, the user interface receives the query as described with reference to FIGS. 3 and 8.

At operation 810, the system generates a first compound score by computing a product of distances between the first ambiguous element and each of a first set of candidate elements corresponding to the first ambiguity category. In some cases, the operations of this step refer to, or are performed by, a candidate selection component as described with reference to FIGS. 3 and 4. In an example, the candidate selection component computes the first compound score as described with reference to FIGS. 4 and 8.

At operation 815, the system generates a second compound score by computing a product of distances between the second ambiguous element and each of a second set of candidate elements corresponding to the second ambiguity category. In some cases, the operations of this step refer to, or are performed by, a candidate selection component as described with reference to FIGS. 3 and 4. In an example, the candidate selection component computes the second compound score as described with reference to FIGS. 4 and 8.

At operation 820, the system compares the first compound score and the second compound score. In some cases, the operations of this step refer to, or are performed by, a query modification component as described with reference to FIG. 3. In an example, the query modification component compares the first compound score and the second compound score as described with reference to FIGS. 3 and 8.

At operation 825, the system generates a modified query by replacing the first ambiguous element and replacing the second ambiguous element after replacing the first ambiguous element based on the comparison. In some cases, the operations of this step refer to, or are performed by, a query modification component as described with reference to FIG. 3. In an example, the query modification component generates the modified query as described with reference to FIGS. 3, 8, and 9.

FIG. 9 shows an example of a method 900 for selecting the modified query of FIG. 8 according to aspects of the present disclosure. At operation 905, the system generates a first set of modified queries by replacing the first ambiguous element with each of the first set of candidate element. In some cases, the operations of this step refer to, or are performed by, a query modification component as described with reference to FIG. 3. In an example, the query modification component generates the first set of modified queries as described with reference to FIGS. 3 and 8.

At operation 910, the system selects a first modified query from the first set of modified queries. In some cases, the operations of this step refer to, or are performed by, a query modification component as described with reference to FIG. 3. In an example, the query modification component selects the first modified query as described with reference to FIGS. 3 and 8.

At operation 915, the system generates a second set of modified queries by replacing the second ambiguous element in the first modified query with each of the second set of candidate elements, where the modified query is selected from the second set of modified queries. In some cases, the operations of this step refer to, or are performed by, a query modification component as described with reference to FIG. 3. In an example, the query modification component generates the second set of modified queries as described with reference to FIGS. 3 and 8.

Accordingly, a method for query disambiguation is described. One or more aspects of the method include obtaining a query including a first ambiguous element and a second ambiguous element, wherein the first ambiguous element corresponds to a first ambiguity category and the second ambiguous element corresponds to a second ambiguity category; generating a first compound score by computing a product of distances between the first ambiguous element and each of a first plurality of candidate elements corresponding to the first ambiguity category; generating a second compound score by computing a product of distances between the second ambiguous element and each of a second plurality of candidate elements corresponding to the second ambiguity category; comparing the first compound score and the second compound score; and generating a modified query by replacing the first ambiguous element and replacing the second ambiguous element after replacing the first ambiguous element based on the comparison.

Some examples of the method further include generating a first plurality of modified queries by replacing the first ambiguous element with each of the first plurality of candidate element. Some examples further include selecting a first modified query from the first plurality of modified queries. Some examples further include generating a second plurality of modified queries by replacing the second ambiguous element in the first modified query with each of the second plurality of candidate elements, wherein the modified query is selected from the second plurality of modified queries.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

The description and drawings described herein represent example configurations and do not represent all the implementations within the scope of the claims. For example, the operations and steps may be rearranged, combined or otherwise modified. Also, in some embodiments, structures and devices are represented in the form of block diagrams to represent the relationship between components and avoid obscuring the described concepts. In some embodiments, similar components or features have the same name but have different reference numbers corresponding to different figures.

Some modifications to the disclosure may be readily apparent to those skilled in the art, and the principles defined herein are applicable to other variations without departing from the scope of the disclosure. Thus, the disclosure is not limited to the examples and designs described herein, but is to be accorded the broadest scope consistent with the principles and novel features disclosed herein.

According to some aspects, the functions described herein are implemented in hardware or software and are executed by a processor, firmware, or any combination thereof. In some embodiments, if implemented in software executed by a processor, the functions are stored in the form of instructions or code on a computer-readable medium.

Computer-readable media includes both non-transitory computer storage media and communication media including any medium that facilitates transfer of code or data. In some embodiments, a non-transitory storage medium is any available medium that is accessible by a computer. Also, in some embodiments, connecting components are properly termed computer-readable media. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” can be based on both condition A and condition B. In other words, the phrase “based on” shall be construed to mean “based at least in part on.” Also, the words “a” or “an” indicate “at least one.”

1. A method implemented by a computing device including at least one processor and at least one memory, the method comprising:
obtaining, by the computing device, a query including text, wherein the text includes an ambiguous element corresponding to an ambiguity category;
selecting, by the computing device, a plurality of candidate elements by retrieving the plurality of candidate elements based on the ambiguity category and computing a distance between the ambiguous element and each of the plurality of candidate elements; and
generating, by the computing device, a plurality of modified queries based on the query by replacing the ambiguous element in the text with each of the plurality of candidate elements, respectively.

2. The method of claim 1, further comprising:
computing an ambiguity score for the ambiguous element; and
detecting the ambiguous element based on the ambiguity score.

3. The method of claim 1, further comprising:
retrieving a plurality of potential candidate elements corresponding to the ambiguity category, wherein the plurality candidate elements are selected from the plurality of potential candidate elements.

4. The method of claim 1, wherein:
the plurality of candidate elements includes at least three candidate elements.

5. The method of claim 1, further comprising:
identifying a user profile, wherein the plurality of candidate elements are selected based on the user profile.

6. The method of claim 1, further comprising:
encoding the ambiguous element to obtain an ambiguous element embedding; and
encoding each of the plurality of candidate elements to obtain a plurality of candidate element embeddings, wherein the distances between the ambiguous element and each of the plurality of candidate elements are computed based on the ambiguous element embedding and the plurality of candidate element embeddings.

7. The method of claim 1, further comprising:
displaying each of the plurality of modified queries; and
receiving a selection input corresponding to a replacement query of the plurality of modified queries.

8. The method of claim 1, further comprising:
generating a response indicating the query includes the ambiguous element; and
displaying the response along with the plurality of modified queries.

9. The method of claim 1, further comprising:
selecting a replacement query from the plurality of modified queries; and
performing a search based on the replacement query.

10. The method of claim 9, further comprising:
retrieving a search result based on the search; and
displaying the search result in response to the replacement query.

11. The method of claim 1, further comprising:
generating a compound score by computing a product of the distances between the ambiguous element and each of the plurality of candidate elements, wherein the plurality of modified queries are generated at least in part on the compound score.

12. The method of claim 11, further comprising:
identifying an additional ambiguous element in the query;
selecting a plurality of additional candidate elements based on the additional ambiguous element; and
generating an additional compound score corresponding to the additional ambiguous element based on the plurality of additional candidate elements.

13. The method of claim 12, further comprising:
comparing the compound score and the additional compound score, wherein the plurality of modified queries are generated by replacing the additional ambiguous element with each of the plurality of additional candidate elements after replacing the ambiguous element with each of the plurality of candidate elements based on the comparison.

14. A method implemented by a computing device including at least one processor and at least one memory, the method comprising:
obtaining, by the computing device, a query including a first ambiguous element and a second ambiguous element, wherein the first ambiguous element corresponds to a first ambiguity category and the second ambiguous element corresponds to a second ambiguity category;
generating, by the computing device, a first compound score by computing a product of distances between the first ambiguous element and each of a first plurality of candidate elements corresponding to the first ambiguity category;
generating, by the computing device, a second compound score by computing a product of distances between the second ambiguous element and each of a second plurality of candidate elements corresponding to the second ambiguity category;
comparing, by the computing device, the first compound score and the second compound score; and
generating, by the computing device, a modified query by replacing the first ambiguous element and replacing the second ambiguous element after replacing the first ambiguous element based on the comparison.

15. The method of claim 14, wherein generating the modified query comprises:
generating a first plurality of modified queries by replacing the first ambiguous element with each of the first plurality of candidate element;
selecting a first modified query from the first plurality of modified queries; and
generating a second plurality of modified queries by replacing the second ambiguous element in the first modified query with each of the second plurality of candidate elements, wherein the modified query is selected from the second plurality of modified queries.

16. An apparatus comprising:
at least one processor;
at least one memory, the at least one memory storing instructions executable by the at least one processor;
a candidate selection component configured to select a plurality of candidate elements by retrieving the plurality of candidate elements based on an ambiguity category and computing a distance between an ambiguous element of text of a query and each of the plurality of candidate elements, wherein the ambiguous element corresponds to the ambiguity category; and
a query modification component configured to generate a plurality of modified queries by replacing the ambiguous element in the text with each of the plurality of candidate elements, respectively, based on the ambiguity category.

17. The apparatus of claim 16, further comprising:
an encoder model configured to encode the ambiguous element to obtain an ambiguous element embedding.

18. The apparatus of claim 16, further comprising:
a user interface configured to receive the query and to display the plurality of modified queries.

19. The apparatus of claim 16, further comprising:
a search component configured to perform a search based on at least one of the plurality of modified queries.

20. The apparatus of claim 16, further comprising:
a language generation model trained to generate a reply to the query.
